(19) United States
(12) Patent Application Publication
(10) Pub. No.: US 2013/0029817 A1
(43) Pub. Date: Jan. 31, 2013

(54) Automatic Tool Changing System for Machine Tool

(71) Applicants: Robert Yellin, Austin, TX (US); Gregory Jackson, Middleton, WI (US); Matthew McNear Doeppers, Fitchburg, WI (US)

(72) Inventors: Robert Yellin, Austin, TX (US); Gregory Jackson, Middleton, WI (US); Matthew McNear Doeppers, Fitchburg, WI (US)

(21) Appl. No.: 13/192,981

(22) Filed: Jul. 28, 2011

(51) Int. Cl. B23Q 3/155

(52) U.S. Cl. 483/58

(57) ABSTRACT

An improved design of an automatic tool changing system for use with a machine tool is disclosed. The design of the tool gripper and tool holder enable reliable tool changes without requiring precise alignment of the machine tool spindle with the tool changer. In addition, the invention is modular in nature and allows an automatic tool changer to be added to a variety of machine tools in a simple and cost effective manner without extensive modification and rewiring.

### BACKGROUND OF THE INVENTION

1. Field of the Invention

The present invention relates generally to automatic tool changers for machine tools, and in particular to automatic tool changers for milling machines.

2. Description of the Prior Art

Milling machines are well known devices in the machine tool art. They are used extensively to perform a variety of machining operations including drilling and cutting. In milling machines a removable rotating tool, often vertically oriented, is secured in and projects downward from the lower end of a power driven spindle which is movable along one axis and mounted to a column. This tool is used to perform machining operations on a workpiece which is typically held on a horizontal table capable of movement along two or more different axes.

A variety of tools are used to perform the various machining operations. Available tools include end mills, face mills, reamers, taps and drill bits. To allow successive operations using various tools to proceed automatically it is necessary to use an automatic tool changer to transfer individual tools between the machine spindle and tool storage. To facilitate this transfer tools are typically mounted in tool holders which have a standard size and shape and allow various sized tools to be easily mounted in a machine tool spindle or in tool storage.

When operations with a given tool are complete the tool holder is disengaged from the spindle and transferred to tool storage. A different tool in its tool holder is then transferred from tool storage to the spindle and the next machining operation proceeds. Tool storage is often a rotatably mounted tool storage carousel. It includes means for securing tool holders. In operation the tool storage carousel is rotated until a desired position is reached at which point a tool holder is either stored or removed from the tool storage carousel.

Automatic tool changers use various means for gripping tool holders during tool changes. These tool grippers also serve to secure tool holders in the tool storage carousel. In addition, these tool grippers must reliably and repeatedly locate tool holders in the proper position relative to the spindle for tool change operations.

Tool grippers and tool holders are designed to function cooperatively together. In the prior art a “V” shaped grove in the tool holder typically mates with a “V” shaped ridge on the tool gripper. Complex mechanisms are often used to rigidly clamp the tool holder in the tool gripper. These mechanisms are necessary if high speed movement of the tool holder is desired, but they add significantly to the cost of the tool gripper and reduce its reliability.

During operation of an automatic tool changer malfunctions or mistakes in programming can occur. These can result in costly damage to the tool changer, the tool holders, and/or the cutting tools. To reduce the possibility of damage it is known in the art to provide a means of reducing damage should a malfunction or mistake occur and cause interference. The methods employed in the prior art require additional parts and added expense, in addition they do not protect against interference from any direction.

Automatic tool changers designed for high speed movement and precise alignment are too expensive for use in small shops and shops that have intermittent use, such as prototype shops and hobby shops. In addition, existing tool changers are designed with power and control signals integrated into the electrical and control systems of a specific machine tool. These tool changers can only be used on the type of machine tool the were designed for. Owners of lower cost machine tools, for which a tool changer system typically has not been designed, are therefore often unable to obtain the advantages of an automatic tool changer.

For the reasons listed above owners of lower cost machine tools are typically unable to obtain the many advantages of an automatic tool changer. There therefore exists a need for an affordable and reliable tool changer that can be easily configured to work with a variety of machine tools and control systems, to serve the small shop, prototype shop, and hobby shop market.

### SUMMARY OF THE INVENTION

In view of the foregoing disadvantages inherent in the prior art the present invention provides an improved modular automatic tool changer system utilizing simple and cost effective tool grippers and tool holders. In addition break away bolts are used to minimize damage in the event of a malfunction or mistake. The simplicity of the system results in high reliability and low cost which will make the system affordable for small shop and prototype shop use. The general purpose of the present invention, which will be described subsequently in greater detail, is to provide a new and improved way of automatically changing tools which has all of the advantages of the prior art and none of the disadvantages.

To achieve this purpose the present invention comprises a modular tool changer system which incorporates composite tool grippers, break away bolts, a “sprung” collet, and tool holders with a special grove to mate with the composite tool grippers.

The modularity allows the tool changer to be easily configured for installation on different machines. The composite tool grippers secure tool holders for movement but allow limited flexibility to ensure tool holders can be readily aligned with the machine tool spindle. The break away bolts protect the tool changer from damage in the event of a mistake or malfunction.

The composite tool grippers are composed of a rigid lower gripper and a compliant upper gripper fastened together with break away bolts. The rigid lower gripper provides structural strength and a precise vertical locating surface and is typically made of metal such as steel or aluminum. Clearance between the inner diameter of the rigid lower gripper and the outer diameter of the tool holder allows the tool holder to “float” horizontally in the composite tool gripper. The compliant upper gripper fits closely around the tool holder and secures and locates the tool holder horizontally while still allowing horizontal flexibility. The compliant upper gripper is typically made of plastic, such as polypropylene co-polymer.

There has thus been broadly outlined the more important features of the invention in order that the detailed description thereof that follows may be better understood, and in order that the present contribution to the art may be better appreciated. There are, of course, additional features of the invention which will be described hereinafter that will form the subject matter of the claims appended hereto.

In this respect, before explaining one embodiment of the invention in detail, it is to be understood that the invention is not limited in its application to the details of construction and to the arrangements of the components set forth in the following description and illustrated in the drawings. The invention is capable of other embodiments and of being practiced and carried out in various ways.

Also, it is to be understood that the phraseology and terminology employed herein are for the purpose of description and should not be regarded as limiting. As such, those skilled in the art will appreciate that the conception, upon which this disclosure is based, may readily be utilized as a basis for the design of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the US Patent and Trademark Office, the public generally, and especially scientists, engineers and practitioners in the art not familiar with patent or legal terms or phraseology to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new and improved modular automatic tool changer system which has all the advantages of the prior art and none of the disadvantages.

It is another object of the present invention to provide a composite tool gripper, tool holder, and a sprung collet which work together cooperatively to improve reliability during tool changes.

It is a further object of the present invention to provide an automatic tool changer system which is modular in nature and can be easily installed on a variety of machine tools.

It is yet a still further object of the present invention to provide automatic tool changer system with break away bolts to minimize damage to the tool changer in the event of a mistake or malfunction.

These, together with other objects of the invention, along with the various features of novelty which characterize the invention, are pointed out with particularity in the claims annexed to and forming a part of this disclosure. For a better understanding of the invention, its operating advantages, and specific objects attained by its uses, reference should be had to the accompanying drawings and descriptive material in which there is illustrated a preferred embodiment of the invention.

### BRIEF DESCRIPTION OF THE DRAWINGS

The invention will be better understood when consideration is given to the following detailed description of the preferred embodiment of the invention. This description makes reference to the following drawings:

FIG. 1 is a perspective view of an automatic tool changer as utilized in the present invention mounted to a milling machine.

FIG. 2 is a perspective view showing the automatic tool changer in the retracted position.

FIG. 3 is a top view showing a tool holder mounted in a tool gripper, the machine spindle and collet.

FIG. 4 is a section view along section line A-A of FIG. 3 showing a tool holder mounted in a tool gripper, the machine spindle and collet.

FIG. 5 is a magnified view of a tool holder mounted in a tool gripper, the machine spindle and collet shown in FIG. 4.

FIG. 6 is a perspective view of a collet.

FIG. 7 is a perspective view showing the automatic tool changer in the tool change position.

FIG. 8 is a perspective view of the automatic tool changer showing a tool stored in the carousel.

FIG. 9 is a top perspective view showing tool grippers mounted to the rotating plate of the storage carousel.

FIG. 10 is a perspective view showing a prior art tool gripper, tool holder and tool.

FIG. 11 is a top perspective view showing a tool gripper, tool holder and tool.

FIG. 12 is a top view showing a tool holder and tool mounted in a tool gripper.

FIG. 13 is a section view along section line B-B of FIG. 12 of a tool holder and tool mounted in a tool gripper.

FIG. 14 is a magnified view of the tool gripper and tool holder interface shown in FIG. 13.

FIG. 15 is a schematic of the automatic tool changer power and control signals.

### DETAILED DESCRIPTION

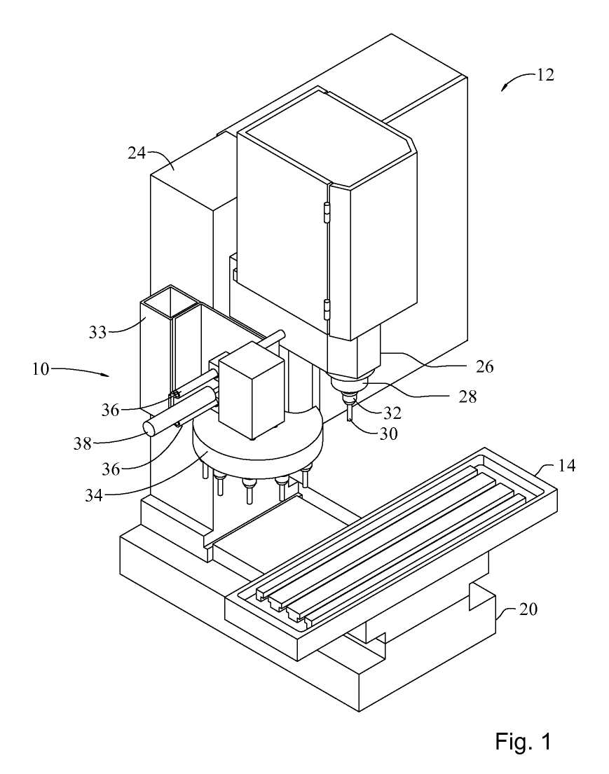

Turning now to the drawing figures, FIG. 1 shows the automatic tool changer generally designated as 10 mounted on a milling machine 12. Mill table 14 is capable of translation in the horizontal plane and is mounted on the mill base 20. Mill column 24 is also mounted on base 20. The column 24 supports spindle head 26 which is capable of translation along a vertical path. Spindle head 26 supports spindle assembly 28. Cutting tool 30 is mounted in tool holder 32 which in turn is mounted in spindle assembly 28.

Tool changer 10 is mounted to mill column 24 using support bracket 33. Tool changer carousel 34 slides on linear rails 36 under the action of cylinder 38. In FIG. 1 tool changer carousel 34 is shown in the retracted position distant from spindle assembly 28.

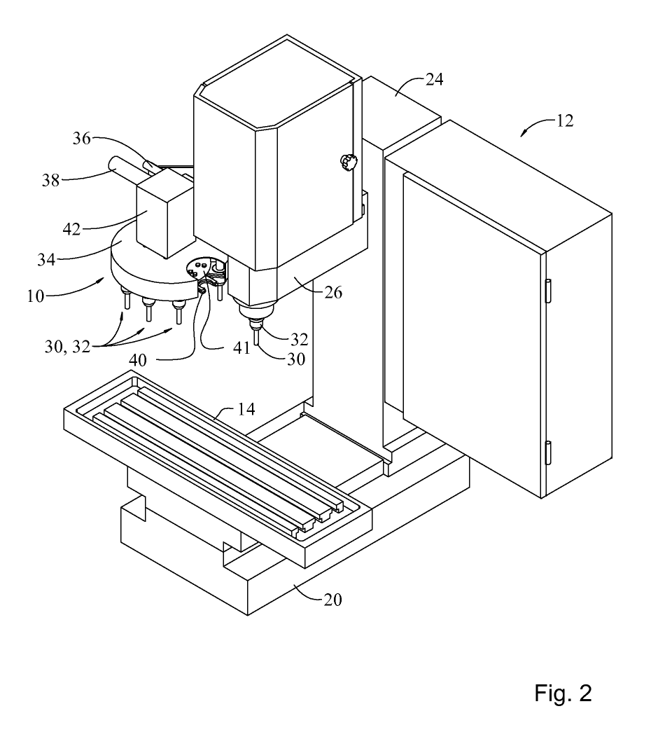

As shown in FIG. 2 a number of cutting tools 30 and tool holders 32 can be stored in tool changer carousel 34. They are held by composite tool grippers 40 which are mounted to rotating plate 41. Rotating plate 41 is rotated in the horizontal plane using conventional driving means 42 as needed to load, remove and store cutting tools 30 and tool holders 32.

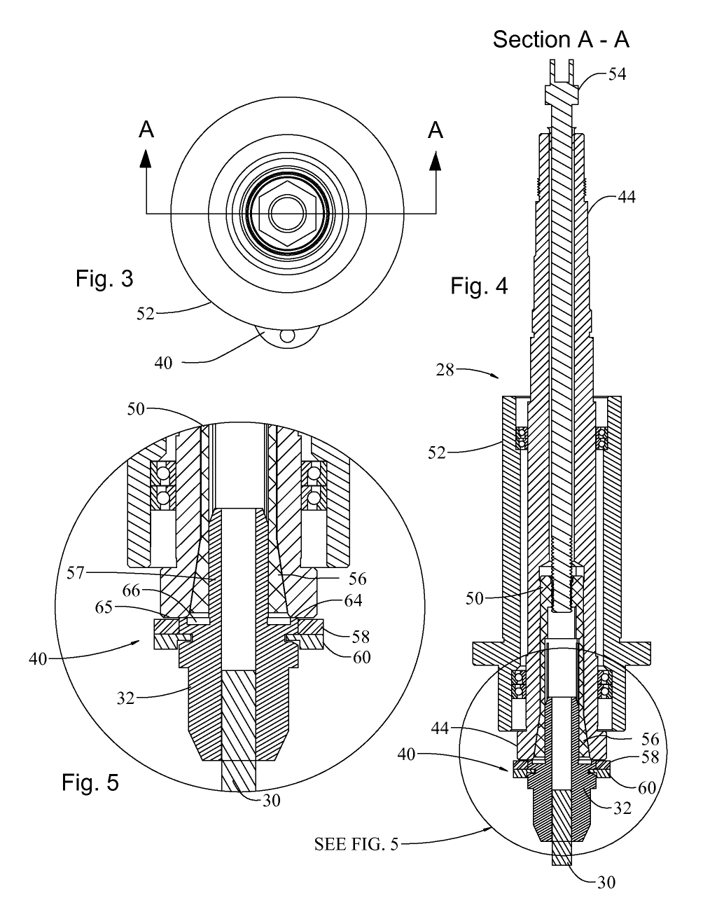

As shown in FIGS. 3, 4 and 5 cutting tool 30 is mounted in tool holder 32. Tool holder 32 is mounted in spindle shaft 44 using collet 50. Spindle shaft 44 rotates in housing 52 of spindle assembly 28. Downward movement of drawbar 54 moves collet 50 down relative to spindle shaft 44. This disengages tapered section 56 at the bottom of collet 50 from spindle shaft 44 and releases the straight shank 57 of tool holder 32 from the grip of collet 50. Upward movement of drawbar 54 moves collet 50 up relative to spindle shaft 44. This engages the tapered section 56 at the bottom of collet 50 with spindle shaft 44 and securely clamps straight shank 57 of tool holder 32 in collet 50.

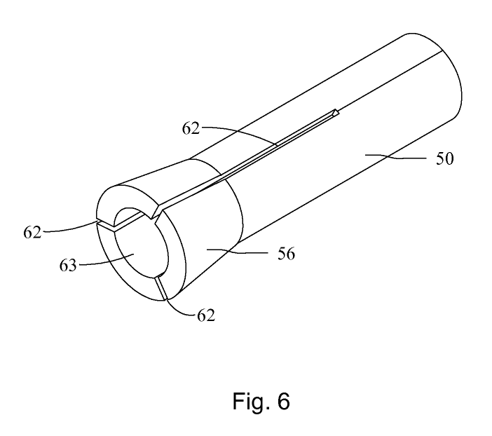

FIG. 6 shows collet 50 in more detail with tapered section 56, slots 62 and inner bore 63. Slots 62 allow the collet to open and close as tapered section 56 is engaged and disengaged from spindle shaft 44.

As best shown in FIG. 5 composite tool gripper 40, composed of upper compliant gripper section 58 and lower rigid gripper section 60, hold tool holder 32 and position it properly for tool change operations. During tool change operations it is critical that shoulder 64 on tool holder 32 is firmly located against bottom face 65 of spindle shaft 44. This ensures that the proper vertical position of tool holder 32 and cutting tool 30 is maintained. Pocket 66 ensures that shoulder 64 does not contact collet 50. Contact with collet 50 would not provide repeatable vertical location of tool holder 32.

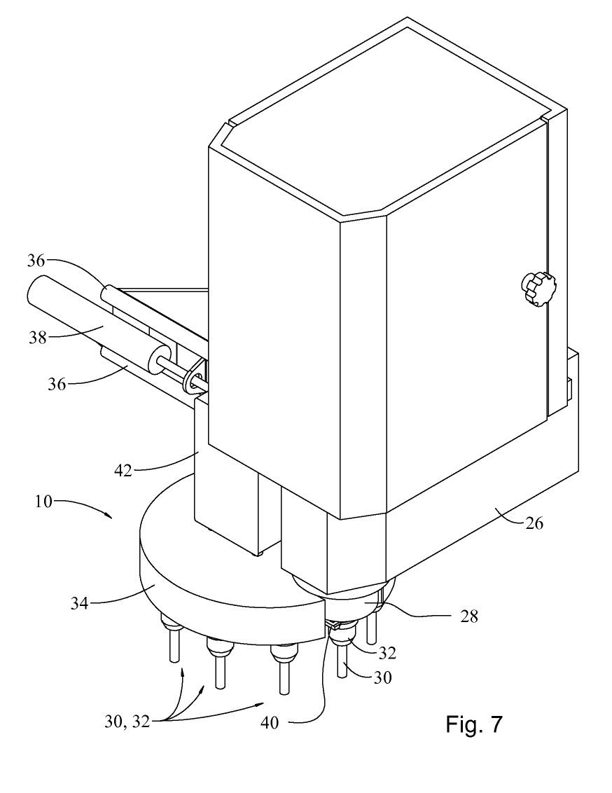

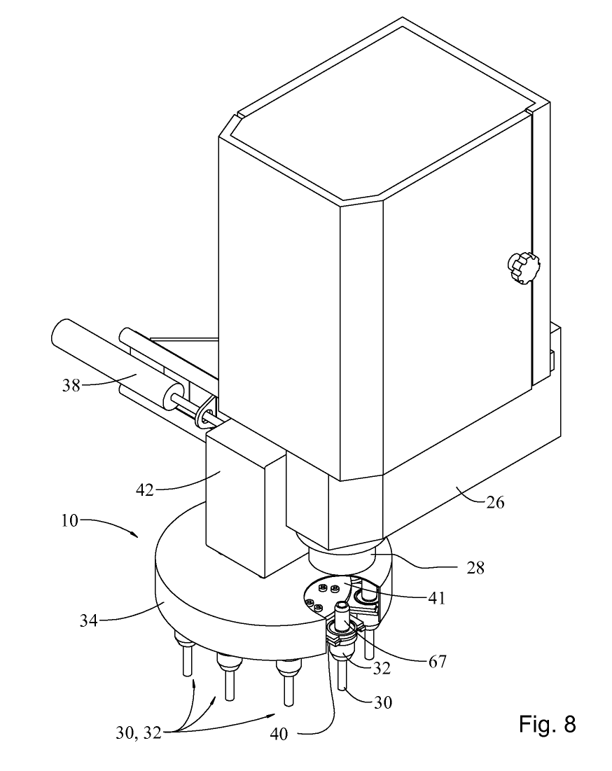

To remove a cutting tool 30 from spindle assembly 28 spindle head 26 is placed at the proper height to align composite tool gripper 40 with tool holder 32 as shown in FIG. 2. Cylinder 38 is actuated to engage composite tool gripper 40 with tool holder 32 mounted in spindle assembly 28 as shown in FIG. 7. Drawbar 54, shown in FIG. 4, is then moved down to disengaging tapered section 56 from spindle shaft 44 which releases tool holder 32 from the grip of collet 50. Spindle head 26 is then raised and tool holder 32 slides out of collet 50 and is held in composite tool gripper 40 as shown in FIG. 8.

To load a cutting tool 30 into spindle assembly 28 spindle head 26 is placed at the proper height to clear tool holder 32 as shown in FIG. 8. Cylinder 38 is actuated to position composite tool gripper 40 with tool holder 32 and cutting tool 30 below spindle assembly 28. Drawbar 54, shown in FIG. 4, is moved down to disengaging tapered section 56 from spindle shaft 44 which opens the inner bore 63 of collet 50 to prepare it to receive tool holder 32.

It is difficult to quickly and reliably locate tool holder 32 so that it is always centered horizontally in inner bore 63 of collet 50. In the prior art inner bore 63 of “R-8” type collet 50 is normally straight with an inner diameter of 0.750 inches. To facilitate smooth entry of straight upper section 67 of tool holder 32 into the inner bore 63 of collet 50 the present invention, in one embodiment, utilizes a “sprung” collet. The bottom end of the inner bore 63 of collet 50 is “sprung” by bending it out between 0.004 inches and 0.012 inches. This slight bend, when combined with tapered section 84 at the top of tool holder 32, significantly improves the smooth entry of straight upper section 67 of tool holder 32 into the inner bore 63 of collet 50.

After cylinder 38 is actuated to position composite tool gripper 40 with tool holder 32 and cutting tool 30 below spindle assembly 28 spindle head 26 is lowered and tool holder 32 slides into inner bore 63 of collet 50. Drawbar 54 is moved up and pulls collet 50 up relative to spindle shaft 44. This engages the tapered section 56 at the bottom of collet 50 with spindle shaft 44 and securely clamps tool holder 32 into collet 50. Cylinder 38 is actuated to disengage composite tool gripper 40 from tool holder 32 and to move tool changer carousel 34 to the tool storage position distant from spindle assembly 28.

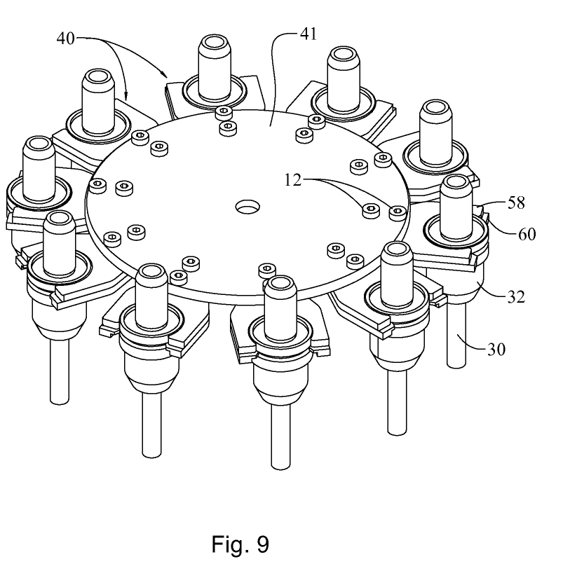

As shown in FIG. 9 composite tool grippers 40 are mounted to rotating plate 41 with break away bolts 12. Break away bolts 12 are made of nylon or another material with a lower yield strength than rotating plate 41 and rigid gripper section 60. In the event an error during tool change operations results in interference between tool holders 32 and composite tool grippers 40 break away bolts 12 will yield and prevent damage to rotating plate 41, tool changer 10, and tool holders 32. Break away bolts 12 will yield in the event of interference in the upward, downward or horizontal direction.

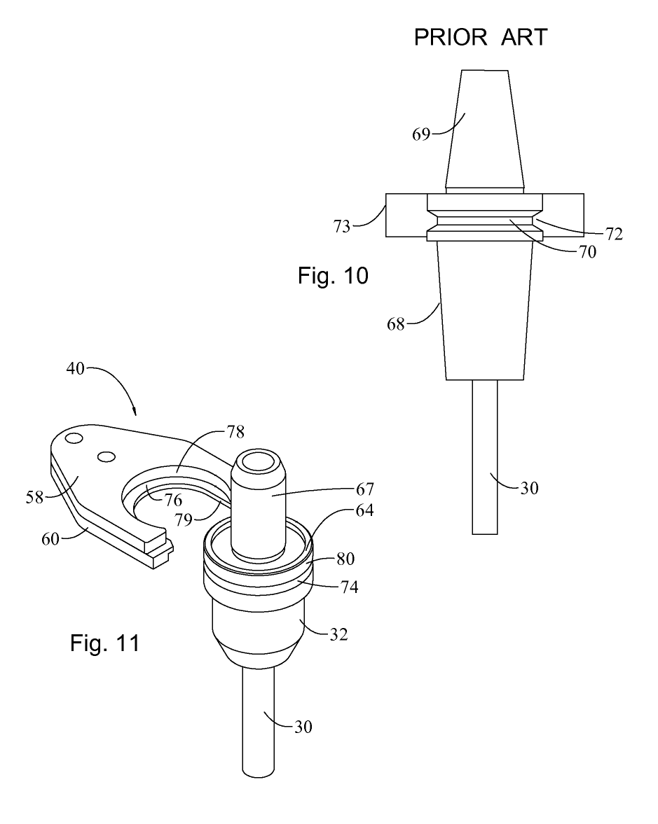

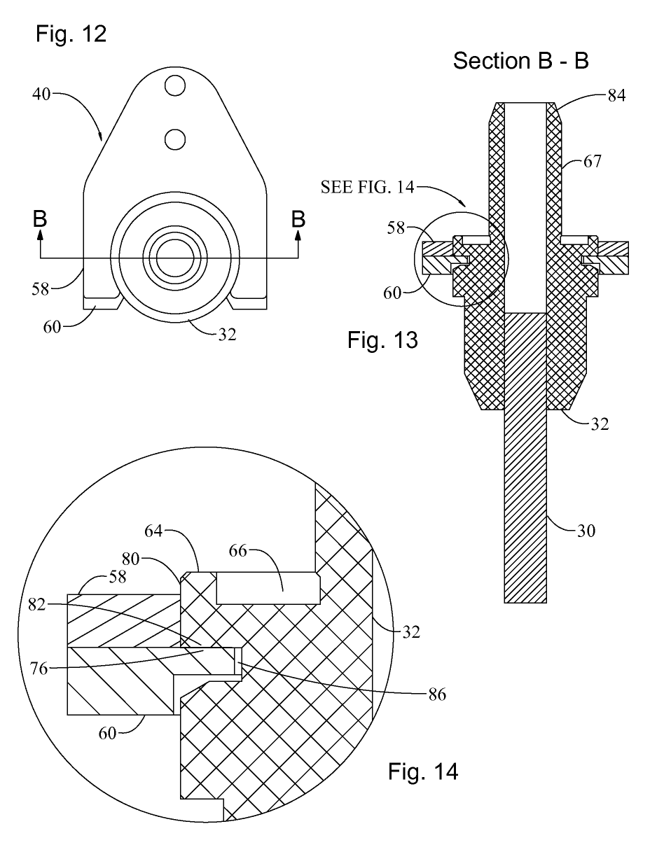

In practice much of the difficulty and cost associated with automatic tool changers is due to the need to accurately position tool holder 32 relative to tool gripper 40 and to collet 50. As shown in FIG. 10 a prior art tool holder 68 has an upper tapered section 69 and a “V” grove 70. “V” grove 70 engages ridge 72 on tool gripper 73. Accurate positioning of tool holder 68 with respect to the machine spindle (not shown) is not required since precision tapered section 69 is pulled upward to engage the machine spindle and by virtue of the taper 69 both horizontal and vertical positioning of the tool holder 68 is readily accomplished. While this prior art design works well it is expensive and requires precise tolerances on tapered section 69 and the machine spindle.

A major problem with automatic tool changers for machine tools using the less expensive R-8 type collet 50 is the correct stable positioning of the tool holder 32 relative to the machine spindle 44 and collet 50 when a tool is loaded into the spindle. The present invention accomplishes this positioning using composite tool gripper 40 and slot 74 on tool holder 32.

As best shown in FIGS. 11 and 14 composite tool gripper 40 is composed of upper compliant gripper section 58 and lower rigid gripper section 60. The pocket 78 of upper compliant gripper section 58 is “C” shaped and fits securely around the upper shoulder 80 of tool holder 32. The pocket 78 of upper compliant gripper section 58 flexes out during tool holder insertion or removal and then returns to its normal position and securely holds tool holder 32. This serves to locate tool holder 32 in the approximately correct horizontal position and allows chamfer 84 at the top of tool holder 32 to enter inner bore 63 of collet 50 as the spindle is lowered onto tool holder 32. As straight upper section 67 of top of tool holder 32 enters into the inner bore 63 of collet 50 compliant gripper section 58 flexes as necessary and allows tool holder 32 to “float” or “swim” in the horizontal direction as needed to provide for a smooth and non-binding entry.

As best shown in FIG. 14 there is a gap 86 between the “U” shaped pocket 79 of lower rigid gripper section 60 and the outer diameter of slot 74 on tool holder 32. Gap 86 is between 0.010 inches and 0.030 inches. Gap 86 provides clearance to allow tool holder 32 smooth and nonbinding entry into pocket 79 of rigid gripper section 60. Gap 86 in combination with flexing of compliant gripper section 58 allows tool holder 32 to “swim” or “float” horizontally as straight upper section 67 of tool holder 32 enters into the inner bore 63 of collet 50. This prevents binding and ensures smooth and reliable operation without the need for expensive precision tolerances on tool holder 32, tool gripper 40 and the entire tool changer mechanism. As best shown in FIG. 14 “U” shaped pocket 79 of lower rigid gripper section 60 is also thinner than the height of slot 74 on tool holder 32 by between 0.020 and 0.050 inches to prevent interference as tool holder 32 is inserted or removed from composite tool gripper 40.

As shown in FIGS. 4, 5, and 6 R-8 type collet 50 has an inner bore 63 which mates with straight upper section 67 of tool holder 32. When straight upper section 67 of tool holder 32 is inserted into the inner bore 63 of collet 50 it is accurately located horizontally, but not vertically. To accomplish vertical location shoulder 64 on tool holder 32, as shown in FIG. 14, must firmly engage the bottom surface 65 of spindle shaft 44 as shown in FIG. 5. To ensure that shoulder 64 firmly engages the bottom surface of spindle shaft 44 tool holder 32 is vertically located when flat top 82 of gap 74 on tool holder 32 rests on upper surface 76 of lower rigid gripper section 60. These two mating horizontal surfaces ensure that tool holder 32 is accurately located vertically and also ensure that the longitudinal axis of tool holder 32 remains parallel to the axis of inner bore 63 of collet 50.

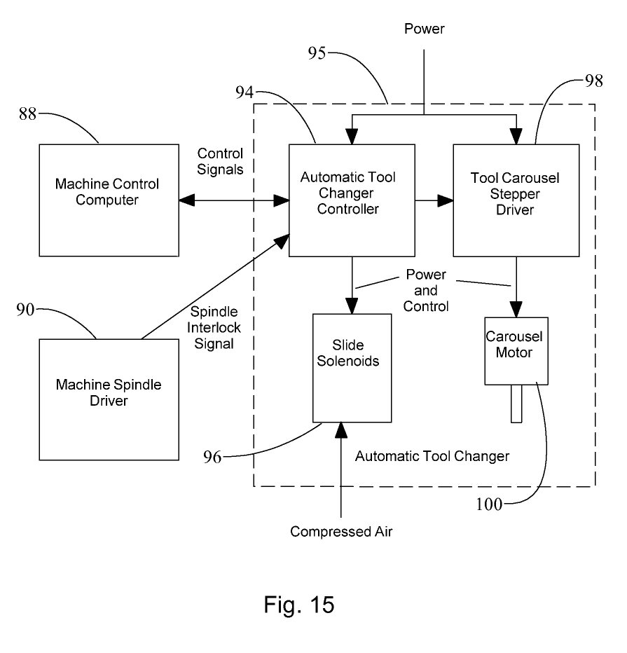

Finally, as shown in FIG. 15, the present invention is modular in terms of power, control signals and compressed air supply. Prior art tool changers are typically designed with power and control signals integrated into the design of a specific machine tool. They cannot be used on a different type of machine tool without extensive modification and rewiring of the machine tool and/or the tool changer.

In the present invention a single USB connection between machine control computer 88 and automatic tool changer controller 94 and a single spindle interlock signal between machine spindle driver 90 and automatic tool changer controller 94 are the only connections required to the machine tool. Automatic tool changer 95 has an independent power supply and an independent controller 94. Upon receipt of digital control signals from machine control computer 88 automatic tool changer controller 94 controls slide solenoids 96 and tool carousel stepper driver 98 as necessary. Stepper driver 98 in turn controls carousel motor 100. Because of its modular nature the automatic tool changer of the present invention can be easily used on a variety of machine tools without extensive hardware modification.

What is claimed is:

1. A tool loading and storage system for an automatic tool changer for a machine tool comprising:
a. a tool storage magazine formed with at least one composite tool gripper for receiving, supporting and discharging a tool holder;
b. said composite tool gripper comprised of a compliant gripper with a generally C-shaped pocket and a rigid gripper with a generally U-shaped pocket;
c. said tool holder formed with an annular slot with an inner diameter smaller than the opening of said generally U-shaped pocket and with an outer shoulder with approximately the same diameter as said generally C-shaped pocket;
d. said compliant gripper deflectable to permit said generally C-shaped pocket to capture and release said tool holder during tool change operations;
e. said compliant gripper deflectable to allow limited movement of said tool holder, while it is captured in said generally C-shaped pocket, in a plane perpendicular to the axis of the spindle of said machine tool to facilitate alignment of said tool holder with said spindle of said machine tool;
f. said limited movement constrained by contact of said inner diameter of said annular slot with said generally U-shaped pocket in said rigid gripper;
g. first engaging means for removing said tool holder from said composite tool gripper and positioning it for insertion in said spindle for machining operations and for returning said tool holder to said composite tool gripper upon completion of a machining operation, and;
h. second engaging means for inserting said tool holder in said machine tool spindle for use in a machining operations and for removing said tool holder from said machine tool spindle upon completion of machining operations.

2. The tool loading and storage system of claim 1 in which said compliant gripper is made of polypropylene co-polymer.

3. The tool loading and storage system of claim 1 in which said composite tool gripper is fastened to said tool storage magazine with fastening means having a lower yield point than said tool storage magazine or said rigid gripper.

4. The tool loading and storage system of claim 3 in which said fastening means are nylon bolts.

5. A tool loading and storage system for an automatic tool changer for a machine tool comprising:
a. a tool storage magazine formed with at least one tool gripper for receiving, supporting and discharging a tool holder;
b. said tool gripper including a rigid gripper portion with a generally U-shaped pocket and a horizontal and flat portion on its upper surface;
c. said tool holder formed with an annular slot with a horizontal and flat upper surface;
d. said horizontal and flat portion on the upper surface of said tool gripper configured to mate with said horizontal and flat upper surface of said annular slot of said tool holder and to thereby fix the vertical position of said tool holder;
e. said tool holder formed with an annular shoulder with a horizontal and flat upper surface configured to mate with the horizontal and flat lower surface of the spindle of said machine tool when the vertical position of said tool holder has been fixed by said tool gripper; and
f. said annular shoulder on said upper surface of said tool holder formed with an annular pocket with an inner diameter larger than the outer diameter of the collet used to hold said tool holder in said spindle of said machine tool.

6. The tool loading and storage system of claim 5 in which said composite tool gripper is fastened to said tool storage magazine with fastening means having a lower yield point than said tool storage magazine or said rigid gripper.

7. The tool loading and storage system of claim 6 in which said fastening means are nylon bolts.

8. The tool loading and storage system of claim 1 with:
a. said rigid tool gripper including a horizontal and flat portion on its upper surface;
b. said tool holder formed with an annular slot with a horizontal and flat upper surface;
c. said horizontal and flat portion on the upper surface of said tool gripper configured to mate with said horizontal and flat upper surface of said annular slot of said tool holder and to thereby fix the vertical position of said tool holder;
d. said tool holder formed with an annular shoulder with a horizontal and flat upper surface configured to mate with the horizontal and flat lower surface of the spindle of said machine tool when the vertical position of said tool holder has been fixed by said tool gripper; and
e. said upper surface of said tool holder formed with an annular pocket with an inner diameter larger than the outer diameter of the collet used to hold said tool holder in said spindle of said machine tool.

9. The tool loading and storage system of claim 8 in which said composite tool gripper is mounted to said tool storage magazine with fastening means having a lower yield point than said tool storage magazine and said rigid gripper.

10. The tool loading and storage system of claim 9 in which said fastening means are nylon bolts.

11. A modular automatic tool changer for a machine tool comprising:
a. an independent power supply for said automatic tool changer;
b. an independent compressed air supply for said automatic tool changer; and
c. an independent automatic tool changer controller configured to operate said automatic tool changer using only software generated instructions received from a machine tool controller via a single universal serial bus (USB) connection and a spindle interlock signal from a machine tool spindle driver.

12. The modular automatic tool changer of claim 11 with a tool loading and storage system comprising:
a. a tool storage magazine formed with at least one composite tool gripper for receiving, supporting and discharging a tool holder;
b. said composite tool gripper comprised of a compliant gripper with a generally C-shaped pocket and a rigid gripper with a generally U-shaped pocket;
c. said tool holder formed with an annular slot with an inner diameter smaller than the opening of said generally U-shaped pocket and with an outer shoulder with approximately the same diameter as said generally C-shaped pocket;
d. said compliant gripper deflectable to permit said generally C-shaped pocket to capture and release said tool holder during tool change operations;
e. said compliant gripper deflectable to allow limited movement of said tool holder while it is captured in said generally C-shaped pocket in a plane perpendicular to the axis of the spindle of said machine tool to facilitate alignment of said tool holder with said spindle of said machine tool;
f. said limited movement constrained by contact of said inner diameter of said annular slot with said generally U-shaped pocket in said rigid gripper;
g. first engaging means for removing said tool holder from said composite tool gripper and positioning it for insertion in said tool spindle for machining operations and for returning said tool holder to said composite tool gripper upon completion of a machining operation, and;
h. second engaging means for inserting said tool holder in said machine tool spindle for use in a machining operations and for removing said tool holder from said machine tool spindle upon completion of machining operations.

13. The tool loading and storage system of claim 12 in which said composite tool gripper is fastened to said tool storage magazine with fastening means having a lower yield point than said tool storage magazine or said rigid gripper.

14. The tool loading and storage system of claim 13 in which said fastening means are nylon bolts.

15. The modular automatic tool changer of claim 11 with:
a. a tool storage magazine formed with at least one tool gripper for receiving, supporting and discharging a tool holder;
b. said tool gripper including a rigid gripper portion with a generally U-shaped pocket and a horizontal and flat portion on its upper surface;
c. said tool holder formed with an annular slot with a horizontal and flat upper surface;
d. said horizontal and flat portion on the upper surface of said tool gripper configured to mate with said horizontal and flat upper surface of said annular slot of said tool holder and to thereby fix the vertical position of said tool holder;
e. said tool holder formed with an annular shoulder with a horizontal and flat upper surface configured to mate with the horizontal and flat lower surface of the spindle of said machine tool when the vertical position of said tool holder has been fixed by said tool gripper; and
f. said upper surface of said tool holder formed with an annular pocket with an inner diameter larger than the outer diameter of the collet used to hold said tool holder in said spindle of said machine tool.

16. The tool loading and storage system of claim 15 in which said composite tool gripper is fastened to said tool storage magazine with fastening means having a lower yield point than said tool storage magazine and said rigid gripper.

17. The tool loading and storage system of claim 16 in which said fastening means are nylon bolts.

18. The modular automatic tool changer of claim 11 with a tool loading and storage system comprising:
a. a tool storage magazine formed with at least one composite tool gripper for receiving, supporting and discharging a tool holder;
b. said composite tool gripper comprised of a compliant gripper with a generally C-shaped pocket and a rigid gripper with a generally U-shaped pocket;
c. said tool holder formed with an annular slot with an inner diameter smaller than the opening of said generally U-shaped pocket and with an outer shoulder with approximately the same diameter as said generally C-shaped pocket;
d. said compliant gripper deflectable to permit said generally C-shaped pocket to capture and release said tool holder during tool change operations;
e. said compliant gripper deflectable to allow limited movement of said tool holder while it is captured in said generally C-shaped pocket in a plane perpendicular to the axis of the spindle of said machine tool to facilitate alignment of said tool holder with said spindle of said machine tool;
f. said limited movement constrained by contact of said inner diameter of said annular slot with said generally U-shaped pocket in said rigid gripper;
g. first engaging means for removing said tool holder from said composite tool gripper and positioning it for insertion in said tool spindle for machining operations and for returning said tool holder to said composite tool gripper upon completion of a machining operation;
h. second engaging means for inserting said tool holder in said machine tool spindle for use in a machining operations and for removing said tool holder from said machine tool spindle upon completion of machining operations;
i. said rigid gripper portion with a horizontal and flat portion on its upper surface;
j. said tool holder formed with an annular slot with a horizontal and flat upper surface;
k. said horizontal and flat portion on the upper surface of said tool gripper configured to mate with said horizontal and flat upper surface of said annular slot of said tool holder and to thereby fix the vertical position of said tool holder;
l. said tool holder formed with an annular shoulder with a horizontal and flat upper surface configured to mate with the horizontal and flat lower surface of the spindle of said machine tool when the vertical position of said tool holder has been fixed by said tool gripper; and
m. said upper surface of said tool holder formed with an annular pocket with an inner diameter larger than the outer diameter of the collet used to hold said tool holder in said spindle of said machine tool.

19. The tool loading and storage system of claim 18 in which said composite tool gripper is mounted to said tool storage magazine with fastening means having a lower yield point than said tool storage magazine and said rigid gripper.

20. The tool loading and storage system of claim 19 in which said fastening means are nylon bolts.
